(19) United States
(12) Patent Application Publication
(10) Pub. No.: US 2024/0159175 A1
(43) Pub. Date: May 16, 2024

(54) GASOLINE PARTICLE FILTER WITH INCREASED FRESH FILTRATION

(71) Applicant: UMICORE AG & CO. KG, Hanau-Wolfgang (DE)

(72) Inventors: Jan SCHOENHABER, Darmstadt (DE); Naina DEIBEL, Pfungstadt (DE); Joerg-Michael RICHTER, Frankfurt (DE); Michael SCHIFFER, Hanau (DE)

(73) Assignee: UMICORE AG & CO. KG, Hanau-Wolfgang (DE)

(21) Appl. No.: 18/550,836

(22) PCT Filed: Mar. 22, 2022
(86) PCT No.: PCT/EP2022/057428

§ 371 Date: Sep. 15, 2023

(30) Foreign Application Priority Data
Mar. 23, 2021 (DE) 102021107130.5

(51) Int. Cl. F01N 3/022; B01D 46/24; B01D 53/94

(52) U.S. Cl. CPC F01N 3/0222; B01D 46/2425; B01D 53/9454; B01D 2255/9155; B01D 2258/012; F01N 2260/06; F01N 2260/14; F01N 2330/06; F01N 2510/06

(57) ABSTRACT

The present invention is directed to a wall-flow filter. Said wall-flow filter contains a powder coating which increases the filtration efficiency only in the fresh state. An exhaust gas system comprising such a wall-flow filter is also claimed.

The present invention is directed to a wall-flow filter. Said wall-flow filter contains a powder coating which increases the filtration efficiency only in the fresh state. An exhaust gas system comprising such a wall-flow filter is also claimed.

The exhaust gas of internal combustion engines in motor vehicles typically contains the harmful gases carbon monoxide (CO) and hydrocarbons (HC), nitrogen oxides (NOₓ), and possibly sulfur oxides (SOₓ), as well as particulates that mostly consist of solid carbon-containing particles and possibly adherent organic agglomerates. These are called primary emissions. CO, HC, and particulates are products of the incomplete combustion of the fuel inside the combustion chamber of the engine. Nitrogen oxides form in the cylinder from nitrogen and oxygen in the intake air when combustion temperatures exceed 1200° C. Sulfur oxides result from the combustion of organic sulfur compounds, small amounts of which are always present in non-synthetic fuels. Compliance in the future with statutory exhaust emission limits for motor vehicles applicable in Europe, China, North America, and India requires the extensive removal of said harmful substances from the exhaust gas. For the removal of these emissions, which are harmful to health and environment, from the exhaust gases of motor vehicles, a variety of catalytic technologies for the purification of exhaust gases have been developed, the fundamental principle of which is usually based upon guiding the exhaust gas that needs purification over a flow-through or wall-flow honeycomb body with a catalytically active coating applied thereto. The catalyst facilitates the chemical reaction of different exhaust gas components, while forming non-hazardous products, such as carbon dioxide, water, and nitrogen.

The flow-through or wall-flow honeycomb bodies just described are also called catalyst supports, carriers, or substrate monoliths, as they carry the catalytically active coating on their surface or in the walls forming this surface. The catalytically active coating is often applied to the catalyst support in the form of a suspension in a so-called coating operation. Many such processes in this sense were published in the past by automotive exhaust-gas catalyst manufacturers (EP1064094B1, EP2521618B1, WO10015573A2, EP1136462B1, U.S. Pat. No. 6,478,874B1, U.S. Pat. No. 4,609,563A, WO9947260A1, JP5378659B2, EP2415522A1, JP2014205108A2).

The operating mode of the internal combustion engine is decisive for the methods of harmful substance conversion possible in the catalyst in each case. Diesel engines are usually operated with excess air, most spark-ignition engines with a stoichiometric mixture of intake air and fuel. “Stoichiometric” means that on average exactly as much air is available for combustion of the fuel present in the cylinder as is required for complete combustion. The combustion air ratio λ (A/F ratio; air/fuel ratio) sets the air mass m_{L,actual} which is actually available for combustion in relation to the stoichiometric air mass m_{L,St}:

$$λ = \frac{{m}_{L , actual}}{{m}_{L , st}}$$

If λ<1 (e.g., 0.9), this means “air deficiency” and one speaks of a rich exhaust gas mixture; λ>1 (e.g., 1.1) means “excess air” and the exhaust gas mixture is referred to as lean. The statement λ=1.1 means that 10% more air is present than would be required for the stoichiometric reaction.

When lean-burn motor vehicle engines are mentioned in the present text, reference is thereby made mainly to diesel engines and to predominantly on average lean-burn spark-ignition engines. The latter are gasoline engines predominantly operating on average with a lean A/F ratio (air/fuel ratio). In contrast, most gasoline engines are predominantly operated with an on average stoichiometric combustion mixture. In this respect, the expression “on average” takes into consideration the fact that modern gasoline engines are not statically operated with a fixed air/fuel ratio (A/F ratio; A value). It is rather the case that a mixture with a discontinuous course of the air ratio λ around λ=1.0 is predetermined by the engine control system, resulting in a periodic change of oxidizing and reducing exhaust gas conditions. This change in the air ratio λ is significant for the exhaust gas purification result. To this end, the A value of the exhaust gas is regulated with a very short cycle time (approx. 0.5 to 5 Hz) and an amplitude Δλ of 0.005≤Δλ≤0.07 around the value λ=1.0. On average, the exhaust gas under such operating states should therefore be described as “on average” stoichiometric. In order to ensure that these deviations do not adversely affect the result of exhaust gas purification when the exhaust gas flows over the three-way catalyst, the oxygen storage materials contained in the three-way catalyst balance out these deviations by absorbing oxygen from the exhaust gas or releasing it into the exhaust gas as needed (R. Heck et al., Catalytic Air Pollution Control, Commercial Technology, Wiley, 2nd edition 2002, p. 87). However, due to the dynamic mode of operation of the engine in the vehicle, further deviations from this state also occur at times. For example, under extreme acceleration or in overrun operation, the operating states of the engine, and thus of the exhaust gas, can be adjusted and can, on average, be hypostoichiometric or hyperstoichiometric. Therefore, stoichiometric-combustion spark-ignition engines have an exhaust gas which is predominantly, i.e., for the majority of the duration of the combustion operation, combusted with an air/fuel ratio that is stoichiometric on average.

The harmful gases carbon monoxide and hydrocarbons from a lean exhaust gas can easily be rendered harmless by oxidation on a suitable oxidation catalyst. In a stoichiometrically operated internal combustion engine, all three harmful gases (HC, CO, and NO_{X}) can be eliminated via a three-way catalyst. The reduction of nitrogen oxides to nitrogen (“denitrification” of the exhaust gas) is more difficult on account of the high oxygen content of a lean-burn engine. A known method is selective catalytic reduction (SCR) of the nitrogen oxides in a suitable catalyst or SCR catalyst for short. This method is currently preferred for the denitrification of lean-engine exhaust gases. The nitrogen oxides contained in the exhaust gas are reduced in the SCR method with the aid of a reducing agent metered into the exhaust tract from an external source. Ammonia is used as the reducing agent, which converts into nitrogen and water the nitrogen oxides present in the exhaust gas at the SCR catalyst. The ammonia used as reducing agent may be made available by metering an ammonia precursor compound, for example urea, ammonium carbamate, or ammonium formate, into the exhaust tract, and by subsequent hydrolysis.

Diesel particulate filters (DPF) or gasoline particulate filters (GPF) with and without additional catalytically active coating are suitable aggregates for removing the particulate emissions. In order to meet the legal standards, it is desirable for current and future applications for the exhaust gas aftertreatment of internal combustion engines to combine particulate filters with other catalytically active functionalities not only for reasons of cost but also for installation space reasons. The use of a particulate filter, whether catalytically coated or not, leads to a noticeable increase in the exhaust-gas back pressure in comparison with a flow-through support of the same dimensions and thus to a reduction in the torque of the engine or possibly to increased fuel consumption. In order to not increase the exhaust-gas back pressure even further, the amounts of oxidic support materials for the catalytically active metals of the catalyst or oxidic catalyst materials are generally applied in smaller quantities in the case of a filter than in the case of a flow-through support. As a result, the catalytic effectiveness of a coated particulate filter is frequently inferior to that of a flow-through monolith of the same dimensions.

There have already been some efforts to provide particulate filters which have good catalytic activity due to an active coating and yet have the lowest possible exhaust-gas back pressure. On the one hand, it has proven to be advantageous if the catalytically active coating is not present as a layer on the wall of a porous wall-flow filter, but instead the wall of the filter is to be interspersed with the catalytically active material (WO2005016497A1, JPH01-151706, EP1789190B1). For this purpose, the particle size of the catalytic coating is selected such that the particles penetrate into the pores of the wall-flow filters and can be fixed there by calcination.

A further functionality of the filter, which can be improved by a coating, is its filtration efficiency, i.e., the filtering effect itself. The increase in the filtration efficiency of catalytically inactive filters is described in WO2012030534A1. In this case, a filtration layer (“discriminating layer”) is created on the walls of the flow channels of the inlet side by the deposition of ceramic particles via a particle aerosol. The layers consist of oxides of zirconium, aluminum, or silicon, preferably in fiber form ranging from 1 nm to 5 μm, and have a layer thickness greater than 10 μm, typically 25 μm to 75 μm. After the coating process, the applied powder particles are calcined in a thermal process.

A coating inside the pores of a wall-flow filter unit by spraying dry particles is described in U.S. Pat. No. 8,388,721 B2. In this case, however, the powder should penetrate deeply into the pores. 20% to 60% of the surface of the wall should remain accessible to soot particles, thus open. Depending on the flow velocity of the powder/gas mixture, a more or less steep powder gradient between the inlet and outlet sides can be adjusted.

The introduction of the powder into the pores, for example by means of an aerosol generator, is also described in EP2727640A1. Here, a non-catalytically coated wall-flow filter is coated using a gas stream containing, for example, aluminum oxide particles in such a way that the complete particles, which have a particle size of 0.1 μm to 5 μm, are deposited as a porous filling in the pores of the wall-flow filter. The particles themselves can realize a further functionality of the filter in addition to the filtering effect. For example, these particles are deposited in the pores of the filter in an amount greater than 80 g/l based on the filter volume. They fill in 10% to 50% of the volume of the filled pores in the channel walls. This filter, both loaded with soot and without soot, has an improved filtration efficiency compared to the untreated filter together with a low exhaust-gas back pressure of the soot-loaded filter.

EP2502661A1 and EP2502662B1 mention further methods for the on-wall coating of filters by powder application. Corresponding apparatuses for applying a powder/gas aerosol to the filter, in which the powder applicator and the wall-flow filter are each separated so that air is sucked in through this space during coating, are also described therein. A further method in which a membrane (“trapping layer”) is produced on the surfaces of the inlet channels of filters in order to increase the filtration efficiency of catalytically inactive wall-flow filters is described in patent specification U.S. Pat. No. 8,277,880B2. The filtration membrane on the surfaces of the inlet channels is produced by sucking a gas stream loaded with ceramic particles (for example, silicon carbide, cordierite) through. After application of the filter layer, the honeycomb body is fired at temperatures greater than 1000° C. in order to increase the adhesive strength of the powder layer on the channel walls.

WO2011151711A1 describes a method by which a dry aerosol is applied to an uncoated or catalytically coated filter. The aerosol is provided by the distribution of a powdered high-melting metal oxide having an average particle size of 0.2 μm to 5 μm and guided through the inlet side of a wall-flow filter by means of a gas stream. In this case, the individual particles agglomerate to form a bridged network of particles and are deposited as a layer on the surface of the individual inlet channels passing through the wall-flow filter. The typical powder loading of a filter is between 5 g and 50 g per liter of filter volume. It is expressly pointed out that it is not desirable to obtain a coating inside the pores of the wall-flow filter with the metal oxide.

Due to the introduction of particulate limits and the simultaneous implementation of real driving emissions (RDE) testing as part of the type approval procedure, there is an acute demand for gasoline particulate filters (GPF) that are characterized by particularly high fresh filtration efficiency. Such filters usually have a particularly high exhaust-gas back pressure, which, as already stated, can lead to reduced engine performance and/or increased fuel consumption. Due to oil ash and soot particles deposited during operation, there is inevitably a further increase in exhaust-gas back pressure and filtration efficiency (FIG. 2 for stable powder).

The object of the present invention was therefore to provide particulate filters which have sufficiently high fresh filtration efficiency, but which have no or only a slight increase in exhaust-gas back pressure during proper operation. These and other objects evident from the prior art to the person skilled in the art are achieved by a wall-flow filter according to the present claim 1. Claim 8 relates to an exhaust gas system according to the invention. The dependent claims dependent on these claims are directed to preferred embodiments of the wall-flow filter according to the invention or the exhaust gas system.

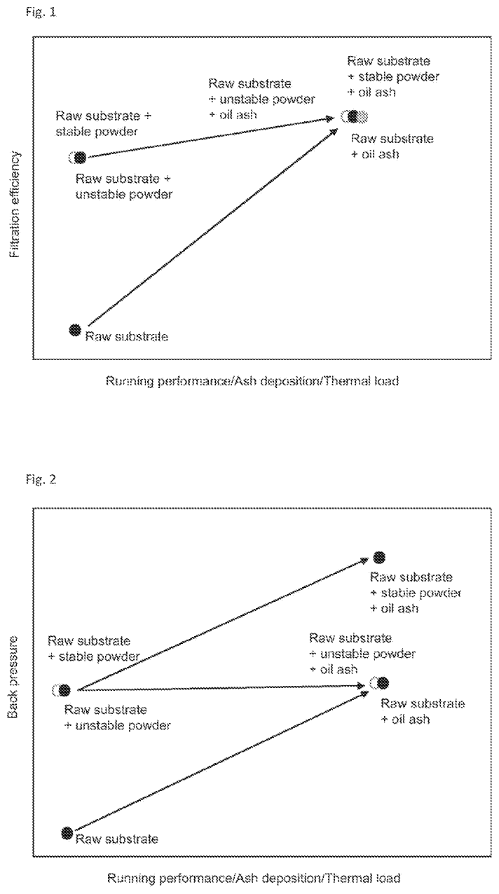

By providing a wall-flow particulate filter for purifying the exhaust gases of a gasoline engine, in which said filter contains on and/or in its input surface a thermolabile powder, which increases the filtration efficiency of the filter in the fresh state and the surface area or volume of which decreases during proper operation of the filter in such a way that an increase in the exhaust-gas back pressure of max. 10% is recorded compared with a filter not treated with the thermolabile powder after an equivalent exposure to particulate exhaust gas constituents, the stated object is achieved in a very simple and elegant, but no less surprising, manner. Due to the thermal load on the filter during normal operation and during regeneration phases, the surface area and volume of the thermolabile powder decreases, such that the proportion of the powder coating in the total backpressure slowly decreases over time. Since the filter simultaneously accumulates e.g. oil ash, the filtration performance remains largely unchanged, despite the decrease in surface area and volume of the thermolabile powder (FIG. 1/2).

All ceramic materials customary in the prior art can be used as wall-flow monoliths or wall-flow filters. Porous wall-flow filter substrates made of cordierite, silicon carbide, or aluminum titanate are preferably used. These wall-flow filter substrates have inflow and outflow channels, wherein the respective downstream ends of the inflow channels and the upstream ends of the outflow channels are alternately closed off with gas-tight “plugs.” In this case, the exhaust gas that is to be purified and that flows through the filter substrate is forced to pass through the porous wall between the inflow channel and outflow channel, which delivers an excellent particulate filtering effect. The filtration property for particulates can be designed by means of the porosity, pore/radii distribution, and thickness of the wall. The porosity of the uncoated wall-flow filters is typically more than 40%, generally from 40% to 75%, particularly from 50% to 70% [measured according to DIN 66133, latest version on the filing date]. The average pore size of the uncoated filters is at least 7 μm, for example from 7 μm to 34 μm, preferably more than 10 μm, in particular more preferably from 10 μm to 25 μm or very preferably from 15 μm to 20 μm [measured according to DIN 66134, latest version on the filing date]. The completed filters with a pore size of typically 10 μm to 20 μm and a porosity of 50% to 65% are particularly preferred.

Within the scope of the invention, the term “thermolabile” is therefore understood to mean the property of exhibiting instability under the influence of elevated temperatures. In the present case, a thermolabile powder is used. According to the invention, the powder therefore consists of a solid which, under the action of sufficient thermal energy, undergoes a transformation such that its density increases. In particular, the volume and surface area of the powder decreases as a result of this heat effect. This can be referred to as sintering of the thermolabile powder. Consequently, the powder presents less volume or surface area to the incoming exhaust gas after the heat effect. Therefore, the exhaust-gas back pressure of the filter decreases as described above. This decrease in exhaust-gas back pressure is compensated for by the oil ash that accumulates in the filter over time and cannot be removed. Therefore, by selecting a suitable powder, ideally its initial filtration efficiency and exhaust-gas back pressure can be kept constant within certain ranges throughout the operation of the filter. The thermolability—the rate at which the powder loses its volume and surface area—should match this ideal as closely as possible. The thermolabile powder should therefore preferably show a reduction in the surface area by 15-50%, preferably 20-40% and very preferably 25-35% after aging for 6 hours in the oven in the presence of air at 1000° C.

The use of a thermolabile powder in the present invention runs counter to the trend that high-surface-area carrier substances for catalytically active metals, which have as thermostable a surface as possible, are normally used in automotive exhaust gas catalytic converters. The more stable the surface, the less a catalyst is subject to thermally induced aging due to sintering of the carrier oxide. In the present case, however, the aim is to allow such a high-surface-area powder to age thermally in a targeted manner. In principle, the same materials can be used for the present invention which also serve as normal carrier oxides in automotive exhaust gas catalytic converters, provided they are in a form which has a thermolability as characterized above. The powder is preferably high-surface-area oxides of metals, e.g., those selected from the group consisting of aluminum oxide, silicon dioxide, cerium oxide, zirconium oxide, titanium dioxide, or mixtures or mixed oxides (solid solutions) thereof. Preferably, the oxides do not have doping with other metals, which leads to better stability. More preferably, the thermolabile powder is aluminum oxide, most preferably an undoped aluminum oxide or mixed oxides of aluminum oxide and silicon oxide, such as, for example, zeolites. In particular, zeolites can be selected or synthesized in a way that is tailored to the present problem. Where the present invention refers to high-surface-area oxides, this means oxides with a BET surface area of more than 10 m²/g, preferably more than 30 m²/g and very particularly preferably more than 50 m²/g. The person skilled in the art knows how to obtain such oxides.

The filter according to the invention can be produced by methods described above as prior art. For this purpose, a metal oxide powder, for example, is commonly mixed with a gas (http://www.tsi.com/Aerosolqeneratoren-und-disperqierer/; https://www.palas.de/de/product/aerosolIeneratorssolidparticles). This mixture of gas and powder produced in this way is then advantageously fed into the inlet side of the wall-flow filter via a gas stream. The term “inlet side” refers to the part of the filter formed by the inflow channels/input channels. The input surface is formed by the wall surfaces of the inflow channels/input channels on the input side of the wall-flow filter. The same applies mutatis mutandis to the outlet side.

All gases considered by the person skilled in the art for the present purpose can be used as gases for producing the aerosol and for inputting into the filter. The use of air is very particularly preferred. However, it is also possible to use other reaction gases which can develop either an oxidizing (e.g., O₂, NO₂) or a reducing (e.g., H₂) activity with respect to the powder used. With certain powders, the use of inert gases (e.g., N₂) or noble gases (e.g., He) may also prove advantageous. Mixtures of the listed gases are also conceivable.

In order for the powder to be deposited sufficiently well on the surface of the filter wall on the inlet side of the filter, a certain suction power is needed. In orientation experiments for the respective filter and the respective powder, the person skilled in the art can form an idea for himself in this respect. It has been found that the aerosol (powder/gas mixture) is preferably sucked through the filter at a velocity of 5 m/s to 50 m/s, more preferably 10 m/s to 40 m/s, and very particularly preferably 15 m/s to 35 m/s. This likewise achieves an advantageous adhesion of the applied powder.

A wall-flow filter produced by the method outlined above should preferably have the powder present in the large pores, as it is mainly these that are responsible for the poor filtration efficiency of the filter. For this purpose, it is preferred that the powder does not fall below a certain particle size (measured according to the latest ISO 13320-1 on the filing date). Usually, the D50 values of the powder are between 1 and 5 μm, preferably between 2 and 4 μm, and most preferably around 3 μm. This preferably blocks the large pores of the filter, such that it has a significantly increased filtration performance, but also a greater back pressure, than the raw substrate.

The filtration performance or, in other words, the filtration efficiency of the powder-containing filter in the fresh state should correspond, as far as possible, to that which results after appropriate proper operation after the oil ash has been deposited. As a rule, the filtration efficiency of the powder-containing filter in the fresh state is between 85%—99.9%, preferably >87% and very particularly preferably >90%. The person skilled in the art knows how to determine the filtration efficiency.

Another essential factor in how to achieve this filtration efficiency is the amount of powder to be deposited in the wall-flow filter. It should not be too high, so as not to create an excessive exhaust-gas back pressure of the filter in the fresh state, but should be large enough to achieve the targeted fresh filtration efficiency. For the wall-flow filters envisaged here, the powder should be applied to the filter in an amount of 1-40 g/l, preferably 1.5-30 g/l, and very preferably 2-25 g/l.

The comparison envisaged according to the invention with regard to the exhaust-gas back pressure of a wall-flow filter treated according to the invention with thermolabile powder and an untreated identical filter, in which the exhaust-gas back pressure increases by max. 10%, preferably max. 7% and particularly preferably max. 5%, after an equivalent exposure to particulate exhaust gas constituents, should be carried out after the filter has been operated properly for a certain time. The filter has in this case already undergone several filter regenerations and the applied powder should at this point in time no longer change its volume or its surface area due to the heat effect. The filter regeneration can also be artificially simulated in appropriate systems. Advantageously, the increase in the exhaust-gas back pressure for the specified comparison is determined after 10 active soot regenerations. During each regeneration, the filter is exposed to temperatures of approx. 700-800° C. for 5-10 minutes. This should be sufficient to allow maximum sintering of the powder in the pores of the wall-flow filter. The test to be assessed here is advantageously based on 10 filter regenerations, each lasting 10 minutes, during which the filter is exposed to a temperature of at least 800° C. for 5 minutes. In the case of artificially induced tests, the amount of ash must therefore be appropriately dimensioned to ensure such a temperature profile.

In a preferred embodiment, the filter may have been catalytically coated prior to the application of the powder/gas aerosol. Here, catalytic coating is understood to mean the ability to convert harmful constituents of the exhaust gas from internal combustion engines into less harmful ones. The exhaust gas constituents NO_{X}, CO, and HC and particles should be mentioned here in particular. This catalytic activity is provided according to the requirements of the person skilled in the art by a coating of the wall-flow filter with a catalytically active material. The term “coating” is accordingly to be understood to mean the application of catalytically active materials to the wall-flow filter. The coating assumes the actual catalytic function. In the present case, the coating is carried out by applying a correspondingly low-viscosity aqueous suspension, also called washcoat, or solution of the catalytically active components to the wall-flow filter, see, for example, according to EP1789190B1. After application of the suspension/solution, the wall-flow filter is dried and, if applicable, calcined at an increased temperature. The catalytically coated filter preferably has a loading of 20 g/l to 200 g/l, preferably 30 g/l to 150 g/l. The most suitable amount of loading of a filter coated in the wall depends on its cell density, its wall thickness, and the porosity. In the case of common medium-porous filters (<60% porosity) with, for example, 200 cpsi cell density and 8 mil wall thickness, the preferred loading is 20 g/l to 50 g/l (based on the outer volume of the filter substrate). Highly porous filters (>60% porosity) with, for example, 300 cpsi and 8 mil have a preferred amount of loading of 25 g/l to 150 g/l, particularly preferably 50 g/l to 100 g/l.

In principle, all coatings known to the person skilled in the art for the automotive exhaust-gas field are suitable for the present invention. The catalytic coating of the filter may preferably be selected from the group consisting of three-way catalyst, SCR catalyst, nitrogen oxide storage catalyst, oxidation catalyst, soot-ignition coating. With regard to the individual catalytic activities coming into consideration and their explanation, reference is made to the statements in WO2011151711A1. Particularly preferably, this has a catalytically active coating having at least one metal-ion-exchanged zeolite, cerium/zirconium mixed oxide, aluminum oxide, and palladium, rhodium, or platinum, or combinations of these noble metals.

The present invention also provides an exhaust gas system comprising a wall-flow filter according to the invention and at least one further unit for reducing harmful exhaust gas constituents, selected from the group consisting of oxidation catalyst, three-way catalytic converter, SCR catalytic converter, hydrocarbon trap and ammonia barrier catalytic converter. The use of an exhaust gas system, which has a three-way catalytic converter close to the engine and a wall-flow filter, likewise positioned close to the engine, with a three-path catalytic coating, is very particularly preferred. It is also preferred if the exhaust gas system, downstream of the three-way catalytic converter close to the engine, has a wall-flow filter according to the invention which is provided with a three-way catalytic coating and is located in the underbody of the vehicle.

Insofar as under-floor (uf) is discussed in the text, in connection with the present invention, this relates to a region in the vehicle in which the catalyst is installed at a distance of 0.2-3.5 m, more preferably 0.5-2 m, and especially preferably 0.7-1.5 m after the end of the first catalyst, close to the engine, of the at least 2 catalysts—preferably, below the driver cabin (FIG. 1).

What is designated as close to the engine (cc) within the scope of this invention is an arrangement of the catalyst at a distance of less than 120 cm, preferably less than 100 cm, and especially preferably less than 50 cm from the exhaust gas outlet of the cylinder of the engine. The catalyst near the engine is preferably arranged directly after the merger of the exhaust gas manifold into the exhaust gas tract.

### THE INVENTION IS EXPLAINED IN MORE DETAIL IN THE FOLLOWING EXAMPLES

### Non-Inventive Comparative Example VGPF1

Aluminum oxide stabilized with lanthanum oxide was suspended in water with a first oxygen storage component, which comprised 40% by weight cerium oxide, zirconium oxide, lanthanum oxide and praseodymium oxide, and a second oxygen storage component, which comprised 24% by weight cerium oxide, zirconium oxide, lanthanum oxide and yttrium oxide. Both oxygen storage components were used in equal parts. The weight ratio of aluminum oxide and oxygen storage component was 30:70. The suspension thus obtained was subsequently mixed with a palladium nitrate solution and a rhodium nitrate solution under constant stirring. The resulting coating suspension was used directly for coating a commercially available wall flow filter substrate, the coating being introduced into the porous filter wall over 100% of the substrate length. The total load of this filter amounted to 75 g/l; the total precious metal load amounted to 1.986 g/l with a ratio of palladium to rhodium of 5:1. The coated filter thus obtained was dried and then calcined. It is hereinafter referred to as VGPF1.

### Comparative Example GPF1 According to the Invention

Aluminum oxide stabilized with lanthanum oxide was suspended in water with a first oxygen storage component, which comprised 40% by weight cerium oxide, zirconium oxide, lanthanum oxide and praseodymium oxide, and a second oxygen storage component, which comprised 24% by weight cerium oxide, zirconium oxide, lanthanum oxide and yttrium oxide. Both oxygen storage components were used in equal parts. The weight ratio of aluminum oxide and oxygen storage component was 30:70. The suspension thus obtained was subsequently mixed with a palladium nitrate solution and a rhodium nitrate solution under constant stirring. The resulting coating suspension was used directly for coating a commercially available wall flow filter substrate, the coating being introduced into the porous filter wall over 100% of the substrate length. The total load of this filter amounted to 75 g/l; the total precious metal load amounted to 1.986 g/l with a ratio of palladium to rhodium of 5:1. The coated filter thus obtained was dried and then calcined. This filter was then coated with an aerosol (powder/gas mixture) in which 7 g/l aluminum oxide was deposited on the filter. This filter is referred to as GPF1 below.

Subsequently, VGPF1 and GPF1 were characterized with respect to their physical properties of filtration efficiency and backpressure behavior. First, the two filters were measured with respect to back pressure on the cold gas test bench at a flow rate of 600 m³/h. The filter VGPF1 had a pressure drop of 36.4 mbar, while the filter GPF1 according to the invention had a corresponding higher back pressure of 42 mbar. This difference corresponds to a 15% increase in the back pressure of GPF1 compared to VGPF1, which is due to the deposition of the aluminum oxide. Subsequently, the two filters were examined on the engine test bench with respect to their filtration performance. For this purpose, the filters were installed in the exhaust tract in a position close to the engine, downstream of a conventional three-way catalytic converter, and measured in the so-called WLTP cycle between two particle counters. The filter VGPF1 showed a filtration efficiency of 60%, while the filter according to the invention had a filtration efficiency of 76% due to the filtration efficiency-increasing coating.

In the remainder of the test, the filter GPF1 was annealed for 10 h at 1100° C. in an air atmosphere and then measured again. This showed that after the temperature exposure on the cold gas test bench, the filter had a back pressure of only 37.1 mbar at the same volume flow rate as before. This corresponds to a back pressure increase of only 2% compared to VGPF1. Although the back pressure of the filter was reduced after the temperature treatment, the filter continues to have an unchanged high filtration performance. This method is thus ideally suited to providing filters that have an initially increased filtration performance and maintain this in continuous operation, while at the same time having an ever-decreasing back pressure during operation due to the sintering of the filtration efficiency material.

1.-9. (canceled)

10. Wall-flow particulate filter for purifying the exhaust gases of a gasoline engine,
characterized in that
said filter contains on and/or in its input surface a thermolabile powder which increases the filtration efficiency of the filter in the fresh state and the surface area or volume of which decreases during proper operation of the filter in such a way that an increase in the exhaust-gas back pressure of max. 10% is recorded compared with a filter not treated with the thermolabile powder after an equivalent exposure to particulate exhaust gas constituents, wherein proper operation is equivalent to 10 active filter regenerations, each lasting 10 minutes, during which the filter is exposed to a temperature of at least 800° C. for 5 minutes.

11. Wall-flow filter according to claim 10,
characterized in that
the thermolabile powder shows a reduction in the surface area by 15-50% after aging for 6 hours in the oven at 1000° C.

12. Wall-flow filter according to claim 10,
characterized in that
an undoped metal oxide selected from the group consisting of aluminum oxide, silicon dioxide, cerium oxide, zirconium oxide, titanium dioxide or mixtures or mixed oxides (solid solutions) thereof is used as the thermolabile powder.

13. Wall-flow filter according to claim 10,
characterized in that
the filtration efficiency of the powder-containing filter in the fresh state is between 85-99.9%.

14. Wall-flow filter according to claim 10,
characterized in that
the powder is applied to the filter in an amount of 1-40 g/l.

15. Wall-flow filter according to claim 10,
characterized in that
the increase in the exhaust-gas back pressure for the indicated comparison is determined after 10 active soot regenerations.

16. Wall-flow filter according to claim 10,
characterized in that
the filter was catalytically coated prior to being exposed to the thermolabile powder.

17. Exhaust gas system comprising a wall-flow filter according to claim 10 and at least one further unit for reducing harmful exhaust gas constituents, selected from the group consisting of oxidation catalyst, three-way catalytic converter, SCR catalytic converter, hydrocarbon trap and ammonia barrier catalytic converter.

18. Exhaust system according to claim 17,
characterized in that
said system has a three-way catalytic converter close to the engine and a wall-flow filter, which is located in the underbody of the vehicle and is provided with a three-way catalytic coating.
